(19) United States
(12) Patent Application Publication
(10) Pub. No.: US 2015/0161669 A1
(43) Pub. Date: Jun. 11, 2015

(54) CONTEXT-AWARE SOCIAL ADVERTISING LEVERAGING WEARABLE DEVICES - OUTWARD-FACING DISPLAYS

(71) Applicants: Giuseppe Beppe Raffa, Portland, OR (US); Francisco Javier Fernandez, Portland, OR (US); Glen J. Anderson, Beaverton, OR (US); Ryan Scott Brotman, Beaverton, OR (US); Jamie Sherman, Portland, OR (US)

(72) Inventors: Giuseppe Beppe Raffa, Portland, OR (US); Francisco Javier Fernandez, Portland, OR (US); Glen J. Anderson, Beaverton, OR (US); Ryan Scott Brotman, Beaverton, OR (US); Jamie Sherman, Portland, OR (US)

(21) Appl. No.: 14/368,481

(22) PCT Filed: Dec. 10, 2013
(86) PCT No.: PCT/US2013/074080

§ 371 Date: Jun. 24, 2014

(51) Int. Cl. G06Q 30/02

(52) U.S. Cl. CPC G06Q 30/0267; G06Q 30/0269

(57) ABSTRACT

Embodiments for providing context-aware social advertising on wearable devices are generally described herein. In some embodiments, a display is provided for presenting content including advertisements. A processor is arranged to determine when an exposure of a display of a wearable device of a first person is acceptable for presentation of an advertisement. A sensor is arranged to obtain information for determining an advertisement to present on the display of the wearable device. The processor is further arranged to select the advertisement to present on the display of the wearable device based on the sensed information and presenting the selected advertisement on the display of the wearable device.

### BACKGROUND

Portable electronic devices, including but not limited to mobile phones, personal digital assistances (PDAs), etc., are frequently used for communication. For example, such electronic devices are used for direct communication and communication over a network, such as a telecommunication network. However, the use of portable electronic devices is not limited strictly to communication, as such devices can also be used for sharing data, listening music, watching stored videos, watching active contents/live contents and the like. For example, a user of a mobile phone can watch videos on the mobile phone, listen to songs, and can send short/multimedia messages.

Furthermore, the user can also share and/or send stored data (e.g. video files) to other electronic devices having a bigger display or screen, if size of a display or screen of the mobile phone is not appropriate for viewing the video. The data can be shared between two electronic devices through a telecommunication network, a short range wireless communication network and the like. For example, a mobile phone can share data file with another electronic device through short range wireless communication, for example, short range radio (Bluetooth®), infrared light (IR) and Near Field Communication (NFC).

While portable electronic devices are pervasive, wearable devices are posed to be a disruptive technology. As such, more and more companies are looking to leverage wearable technology to perform various functions such as mobile social advertising, thereby going beyond simply showing advertisements to the user. However, techniques for social advertising still rely, at best, on advertisements showing up on the user screen or on electronic billboards. Low-tech solutions include branded clothes or logos on clothes (i.e. logos on celebrities' clothes) and even people being paid for having tattoos of some brands.

Some solutions have been proposed that display advertisements on screens of devices of a user and reward them in several ways for the screen utilization. However, even with these developments, there are issues still not resolved. For example, the loop between the advertiser and the consumer has not been closed in order to assess effectiveness of the advertisement. Further, there is no mechanism that makes use of the capabilities made possible by wearable devices, such as screens/displays, which may possibly be visible to other people nearby and which may sense or have context awareness of such nearby devices.

### BRIEF DESCRIPTION OF THE DRAWINGS

FIG. 1 illustrates a system for providing context-aware social advertising on wearable devices according to an embodiment;

FIG. 2 is a flowchart of a method for providing context-aware social advertising on wearable devices according to an embodiment; and

FIG. 3 illustrates a block diagram of an example machine for providing context-aware social advertising on wearable devices according to an embodiment.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass available equivalents of those claims.

Embodiments described herein maximize effectiveness of social advertising. The capabilities of wearable devices, in particular in social settings, are leveraged wherein a device of a user may be visible to other people nearby. Rather than addressing social advertisement rely based on a one-way relationships between the advertiser and the user and a static configuration, e.g., banners displayed on a screen, sensing technologies are exploited to maximize effectiveness of social advertising using wearable devices. Embodiments described herein exploit sensing and context technologies to provide a mechanism to infer the best way to show an advertisement on wearable devices worn by the user to maximize exposure to nearby people and to provide a mechanism to infer effectiveness of a displayed advertisement.

Advertisement content is adapted based on information sensed from the devices worn by users, devices nearby and environmental context. The screen exposure may be determined, e.g., facing outward from the user and hence visible to others. Relevant advertisements may be shown depending on a number of factors, such as the number or identity of people nearby, user preferences and context, location and shops nearby, or previous history. Feedback from nearby users may be gathered with various techniques and communicated back to the advertiser. As such, a closed loop from advertisers to user willing to show advertisements on their wearable devices to final consumers of the advertisements can be formed, hence providing a mechanism for personal wearable data economy. In short, this description enables the emergence of data economy and social advertising by exploiting novel capabilities in wearable devices.

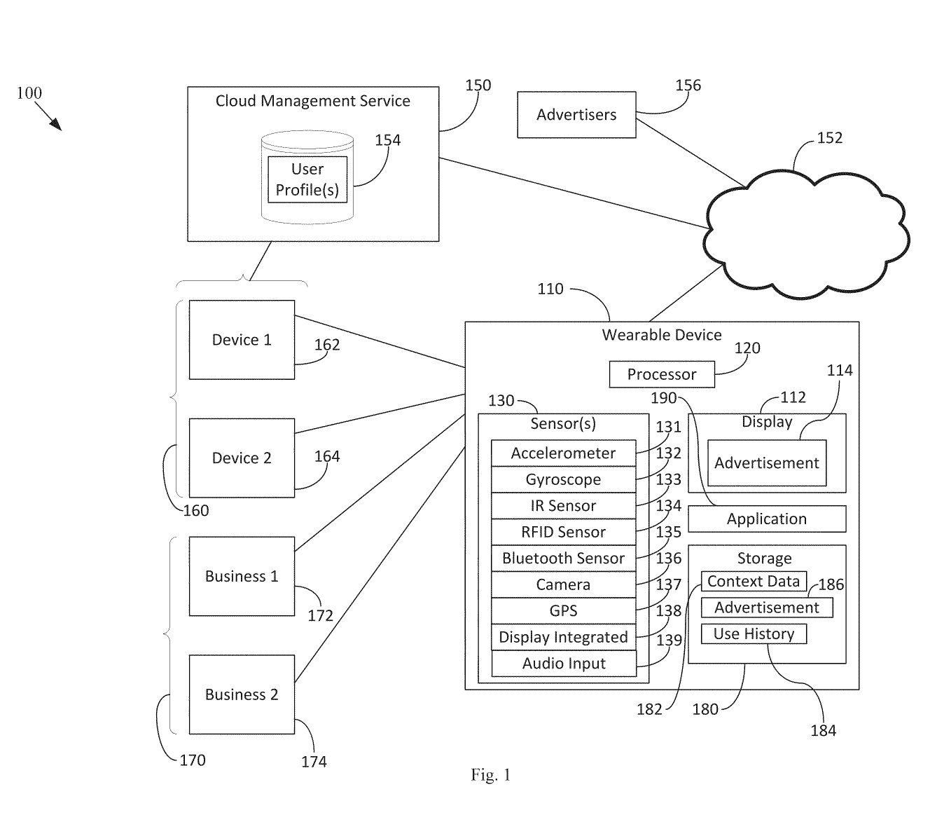

FIG. 1 illustrates a system 100 for providing context-aware social advertising on wearable devices according to an embodiment. Wearable technology, wearable devices, or fashion electronics include clothing and accessories which can comfortably be worn on the body that incorporate computer and advanced electronic technologies. The designs often incorporate practical functions and features, but may also have an artistic or creative aspect. Along with cloud-enabled headgear, wearable technology may also include fitness monitors, smart watches, wearable cameras, people tracking devices, smart clothing or e-textiles, etc. In FIG. 1, a wearable device 110 provides context-aware social advertising according to an embodiment. A display 112 presents content including advertisements 114. A processor 120 is arranged to determine when an exposure of the display 112 of the wearable device 110 of a first person is acceptable for presentation of the advertisement 114. A sensor 130 may obtain information from nearby users and devices to use as a basis for determining what advertisement 114 to present on the display 112 of the wearable device 110.

The wearable device 110 may access a cloud management service 150 through a network 152. The network 152 may be the internet, a WiFi network, a cellular network, etc. Nearby devices 160, such as device 1 162 and device 2 164 may also access the cloud management service 150. The cloud management service 150 may store information including user profiles 154. The user profiles 154 may be configured by the owner of a wearable device 110 or other device capable of accessing the cloud management service 150. The nearby devices 160 may also communicate with the wearable device 110. Further, nearby businesses 170, such as business 1 172 and business 2 174, may communicate with the wearable device 110. The nearby businesses 170, or other advertisers 156, may provide advertisements 114 that may be presented on the display 112 of the wearable device 110. For example, the nearby businesses 170 may stream local advertisements 114 that a wearable device 110 may sense when proximate to the nearby businesses 170. However, an advertisement 186 may be stored online, such as in cloud management device 150 or another database, such as storage 180 of the wearable device 110, and then provided to the processor 120 based on a predetermined trigger, e.g., a location, sensing of a predetermined factor by the wearable device 110, etc.

The processor 120 of the wearable device 110 may select the advertisement 186 to present on the display 112 of the wearable device 110 based on sensed information. The display 112 of the wearable device 110 then presents the advertisement 114 to the user. The processor 120 may determine when the display 112 is pointing outward based on information obtained by the sensor 130, including the position and orientation of the display 112 of the wearable device 110 on the wrist and with respect to the user field of view, to determine when the exposure of the display 112 of the wearable device 110 is acceptable for presentation of the advertisement 114 on the display 112.

A sensor 130 of the wearable device 110 may include an accelerometer 131, a gyroscope 132, an infrared (IR) sensor 133, a radio frequency identification (RFID) sensor 134, a Bluetooth low energy sensor 135, a camera 136, a global positioning system (GPS) sensor 137, a sensor integrated into the display of the wearable device 138, an audio sensor 139 for obtaining audio input (e.g., microphones), etc. In addition to other functions, the sensor(s) 130 may be used to obtain information for determining whether the display 112 is pointing outward and not in the field of view of the user. Still further, the sensor(s) 130 may obtain information from the wearable device 110, from nearby devices 160 of others, from context 182, from user preferences in a profile 154, and from a global position system (GPS) 137, e.g., location data. Such information obtained may be associated with identification of nearby businesses 170, a history 182 of use of the wearable device 110, etc.

The wearable device 110 may recognize people facing the device and contextually swap the advertisement based on features of those people. For example, the wearable device 110 may include a camera 136 with blob detection or another method, wherein the wearable device 110 may determine that the user is facing the camera 136. The camera 136 may capture an image of the user and upload the image to Google Images™ search service. A search may reveal the identity of the user and grab key words associated with the things the user purchases. The processor 120 may then determine the appropriate advertisement 186 to post on the wearable device 110 based on the key word grab.

The processor 120 selects the advertisement 186, for example from storage 180, to present on the display 112 of the wearable device 110 based on user preferences from the profile 154, detection of nearby businesses and profiles 154 associated with nearby devices. Advertisement 114 presented on the display 112 may be based on context information 182. To be less disruptive for the user, context technologies can be utilized to provide context information 182 to determine how an advertisement 114 is shown, e.g., context information may be used to predict user activity. Context information 182 may also be used to predict how much time the user will stay disconnected from a power source, which may pose constraints on the type of content that may be shown, e.g., power-hungry videos may be avoided to reduce power consumption by the device 110. For example, history data, location, etc. may be used to identify how the user is using a device 110 and thus whether the user is connected to a power source.

The processor 120 may communicate real-time feedback from the nearby devices 160. A user having a device, such as Device 1 162, may perform an interaction with the wearable device 110 to obtain the advertisement 114 presented on the display 112 of the wearable device 110. An application 190 may be provided to allow the user of the wearable device 110 to communicate with the advertisement 114 being presented on the display 112. User profiles 154 at the cloud management service 150 may be set up via the wearable device 110 and/or devices of other users, such as nearby devices 160. The user may also select companies to advertise and to track and collect rewards based on advertisement 114 presented on the display 112 of the wearable device 110. Feedback from nearby users 160 may be received and processed by the processor 120 and then communicated to advertisers 156. As described earlier, feedback from nearby users may be gathered with various techniques and provided to the processor 120. Such techniques may include sensors that obtain information from nearby users passively. Alternatively, or in addition to, techniques for obtaining user feedback may be based on active feedback where users communicate the feedback to the device 110 of the user.

The processor 120 may also analyze a history 184 of advertisements presented on the display 112 of the wearable device 110. The user may set up the system, for example, by choosing which companies or categories of companies, i.e. green companies, to advertise, track and collect rewards based on advertisement activity of the user and other factors. Analytics on a server can be utilized to suggest companies, categories of companies and advertisements to present on the display 112 of the wearable device 110 to close the loop between the advertisers 156 and the user.

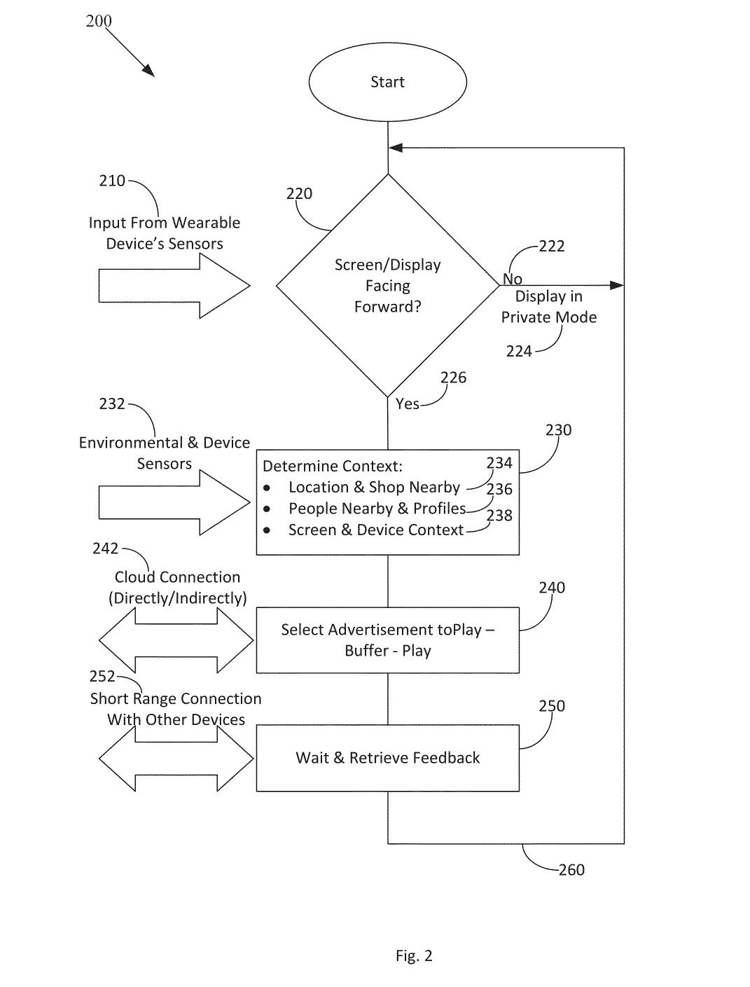

FIG. 2 is a flowchart of a method for providing context-aware social advertising on wearable devices according to an embodiment. In FIG. 2, sensors of the wearable device provide input 210 which allows a decision of whether the screen or display of the device is facing outward 220. If the display is not facing outward 222, no action is taken and display remains in private mode 224. If the display of the device is determined to be facing outward 226, a context is determined 230. Context is based on measurements from environmental and device sensors 232. For example, the location and identification of a shop or business nearby may be detected 234. People that are nearby may be detected along with their profiles 236. In addition, the context for the screen and the device may be taken into account 238. An advertisement may be selected to play. The advertisement may be buffered prior to being played 240. The advertisement may be obtained via a cloud connection, either directly or indirectly 242. The wearable device may then wait for feedback 250. Short range connections with other devices may be used to obtain such feedback 252. The process 200 then may repeat 260.

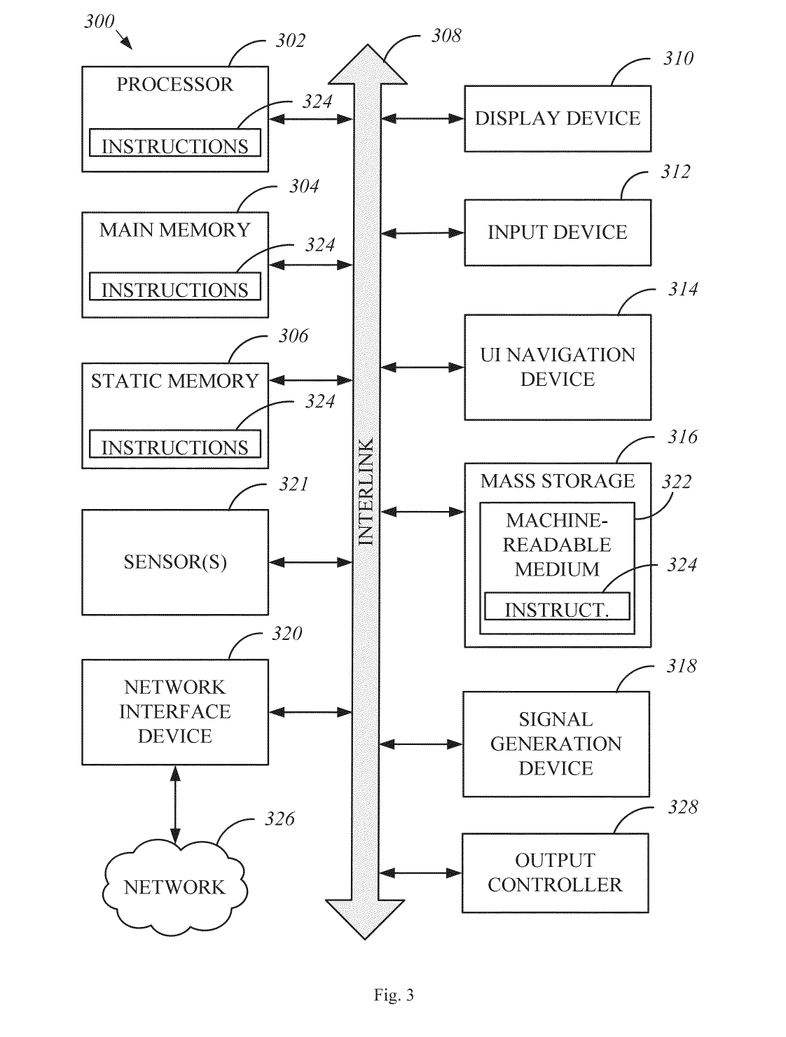

FIG. 3 illustrates a block diagram of an example machine 300 for providing context-aware social advertising on wearable devices according to an embodiment upon which any one or more of the techniques (e.g., methodologies) discussed herein may perform. In alternative embodiments, the machine 300 may operate as a standalone device or may be connected (e.g., networked) to other machines. In a networked deployment, the machine 300 may operate in the capacity of a server machine and/or a client machine in server-client network environments. In an example, the machine 300 may act as a peer machine in peer-to-peer (P2P) (or other distributed) network environment. The machine 300 may be a personal computer (PC), a tablet PC, a set-top box (STB), a Personal Digital Assistant (PDA), a mobile telephone, a web appliance, a network router, switch or bridge, or any machine capable of executing instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, at least a part of one or more computer systems (e.g., a standalone, client or server computer system) or one or more hardware processors 302 may be configured by firmware or software (e.g., instructions, an application portion, or an application) as a module that operates to perform specified operations. In an example, the software may reside on at least one machine readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform at least part of any operation described herein. Considering examples in which modules are temporarily configured, a module need not be instantiated at any one moment in time. For example, where the modules comprise a general-purpose hardware processor 302 configured using software; the general-purpose hardware processor may be configured as respective different modules at different times. Software may accordingly configure a hardware processor, for example, to constitute a particular module at one instance of time and to constitute a different module at a different instance of time. The term “application,” or variants thereof, is used expansively herein to include routines, program modules, programs, components, and the like, and may be implemented on various system configurations, including single-processor or multiprocessor systems, microprocessor-based electronics, single-core or multi-core systems, combinations thereof, and the like. Thus, the term application may be used to refer to an embodiment of software or to hardware arranged to perform at least part of any operation described herein.

Machine (e.g., computer system) 300 may include a hardware processor 302 (e.g., a central processing unit (CPU), a graphics processing unit (GPU), a hardware processor core, or any combination thereof), a main memory 304 and a static memory 306, at least some of which may communicate with others via an interlink (e.g., bus) 308. The machine 300 may further include a display unit 310, an alphanumeric input device 312 (e.g., a keyboard), and a user interface (UI) navigation device 314 (e.g., a mouse). In an example, the display unit 310, input device 312 and UI navigation device 314 may be a touch screen display. The machine 300 may additionally include a storage device (e.g., drive unit) 316, a signal generation device 318 (e.g., a speaker), a network interface device 320, and one or more sensors 321, such as a global positioning system (GPS) sensor, compass, accelerometer, or other sensor. The machine 300 may include an output controller 328, such as a serial (e.g., universal serial bus (USB), parallel, or other wired or wireless (e.g., infrared (IR)) connection to communicate or control one or more peripheral devices (e.g., a printer, card reader, etc.).

The storage device 316 may include at least one machine readable medium 322 on which is stored one or more sets of data structures or instructions 324 (e.g., software) embodying or utilized by any one or more of the techniques or functions described herein. The instructions 324 may also reside, at least partially, additional machine readable memories such as main memory 304, static memory 306, or within the hardware processor 302 during execution thereof by the machine 300. In an example, one or any combination of the hardware processor 302, the main memory 304, the static memory 306, or the storage device 316 may constitute machine readable media.

While the machine readable medium 322 is illustrated as a single medium, the term “machine readable medium” may include a single medium or multiple media (e.g., a centralized or distributed database, and/or associated caches and servers) that configured to store the one or more instructions 324.

The term “machine readable medium” may include any medium that is capable of storing, encoding, or carrying instructions for execution by the machine 300 and that cause the machine 300 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 324 may further be transmitted or received over a communications network 326 using a transmission medium via the network interface device 320 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks ((e.g., channel access methods including Code Division Multiple Access (CDMA), Time-division multiple access (TDMA), Frequency-division multiple access (FDMA), and Orthogonal Frequency Division Multiple Access (OFDMA) and cellular networks such as Global System for Mobile Communications (GSM), Universal Mobile Telecommunications System (UMTS), CDMA 2000 1x* standards and Long Term Evolution (LTE)), Plain Old Telephone (POTS) networks, and wireless data networks (e.g., Institute of Electrical and Electronics Engineers (IEEE) 802 family of standards including IEEE 802.11 standards (WiFi), IEEE 802.16 standards (WiMax®) and others), peer-to-peer (P2P) networks, or other protocols now known or later developed.

For example, the network interface device 320 may include one or more physical jacks (e.g., Ethernet, coaxial, or phone jacks) or one or more antennas to connect to the communications network 326. In an example, the network interface device 320 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 300, and includes digital or analog communications signals or other intangible medium to facilitate communication of such software.

Additional Notes & In Examples

Example 1 includes subject matter (such as a device, apparatus, client or system) for a serving node, including a display for presenting content including advertisements, a processor arranged to determine when an exposure of a display of a wearable device of a first person is acceptable for presentation of an advertisement and a sensor arranged to obtain information for determining an advertisement to present on the display of the wearable device, wherein the processor is further arranged to select the advertisement to present on the display of the wearable device based on the sensed information and presenting the selected advertisement on the display of the wearable device.

In Example 2 the subject matter of Example 1 may optionally include, wherein the processor is further arranged to determine when the display is pointing outward based on information obtained by the sensor, including the position and orientation of the display of the wearable device, to determine when the exposure of the display of the wearable device is acceptable for presentation of an advertisement.

In Example 3 the subject matter of any one or more of Examples 1-2 may optionally include, wherein the processor is further arranged to obtain a reading from at least one sensor selected from a group consisting of an accelerometer, a gyroscope and at least one infrared (IR) sensor to determine that the display is pointing outward and not in the field of view of the user.

In Example 4 the subject matter of any one or more of Examples 1-3 may optionally include, wherein the sensor obtains information from the wearable device, from nearby devices of others, from environmental contexts, from user preferences in a profile, regarding a location, regarding identification of nearby businesses and regarding a history of use of the wearable device.

In Example 5 the subject matter of any one or more of Examples 1-4 may optionally include, wherein the sensor comprises at least one selected from a group consisting of an IR sensor, a camera, a sensor integrated into the display of the wearable device, a radio frequency identification (RFID) sensor, an audio sensor and a Bluetooth low energy sensor.

In Example 6 the subject matter of any one or more of Examples 1-5 may optionally include, wherein the processor selects the advertisement to present on the display of the wearable device based on user preferences, detection of nearby businesses and a profile associated with nearby devices.

In Example 7 the subject matter of any one or more of Examples 1-6 may optionally include, wherein the processor is further arranged to select the advertisement to present on the wearable device using context information to determine how the advertisement are shown and how much time the user will stay disconnected from a power source for identifying a type of content to present.

In Example 8 the subject matter of any one or more of Examples 1-7 may optionally include, wherein the processor is further arranged to perform one selected from the group consisting of communicating real-time feedback from the nearby users to the wearable device presenting the advertisement, performing an interaction with a device of a second person to provide the advertisement to the device of the second person, communicating with the advertisement being presented using an application installed on the wearable device, setting up a user profile of the first person on a cloud management service component and selecting companies to advertise and to track and collect rewards based on advertisements presented on the wearable device.

In Example 9 the subject matter of any one or more of Examples 1-8 may optionally include, wherein the processor is further arranged to receive feedback from nearby users, to communicate the feedback to advertisers; to analyze a history of advertisements presented on the wearable device and to receive suggestions for companies and categories of companies to be presented to close the loop between the advertisers and the user.

Example 10 may include subject matter (such as a method or means for performing acts) including determining when an exposure of a display of a wearable device of a first person is acceptable for presentation of an advertisement, sensing information for determining an advertisement to present, selecting the advertisement to present on the wearable device based on the sensed information and presenting the selected advertisement on the display of the wearable device.

In Example 11 the subject matter of Example 10 may optionally include, wherein the determining when the exposure of the display of the wearable device is acceptable for presentation of the advertisement further comprises determining that the display is pointing outward based on at least one sensor including detecting the position and orientation of the wearable device.

In Example 12 the subject matter of any one or more of Examples 10-11 may optionally include, wherein the determining that the display is pointing outward based on at least one sensor comprises obtaining a reading from at least one selected from a group consisting of an accelerometer, a gyroscope and at least one infrared (IR) sensor.

In Example 13 the subject matter of any one or more of Examples 10-12 may optionally include, wherein the sensing information for determining the advertisement to present comprises sensing information from the wearable device, from nearby devices of others and from environmental contexts.

In Example 14 the subject matter of any one or more of Examples 10-13 may optionally include, wherein the sensing information for determining the advertisement to present comprises sensing information from user preferences in a profile, a location, identification of nearby businesses and a history of use of the wearable device.

In Example 15 the subject matter of any one or more of Examples 10-14 may optionally include, wherein the sensing information from nearby devices of others comprises sensing information from nearby devices of others using an IR sensor, a camera, sensors integrated into the display of the wearable device, a radio frequency identification (RFID) sensor, an audio sensor and a Bluetooth low energy sensor.

In Example 16 the subject matter of any one or more of Examples 10-15 may optionally include, wherein the selecting the advertisement to present on the wearable device based on the sensed information further comprises determining an advertisement to present on the wearable device based on user preferences, detection of nearby businesses and a profile associated with nearby devices.

In Example 17 the subject matter of any one or more of Examples 10-16 may optionally include, wherein the selecting the advertisement to present on the wearable device based on the sensed information further comprises selecting the advertisement to present on the wearable device using context information to determine how the advertisement should be shown and how much time the user will stay disconnected from a power source for identifying a type of content to present.

In Example 18 the subject matter of any one or more of Examples 10-17 may optionally include, further comprising communicating real-time feedback from the nearby users to the wearable device presenting the advertisement.

In Example 19 the subject matter of any one or more of Examples 10-18 may optionally include, performing an interaction with a device of a second person to provide the advertisement to the device of the second person.

In Example 20 the subject matter of any one or more of Examples 10-19 may optionally include, communicating with the advertisement being presented using an application installed on the wearable device.

In Example 21 the subject matter of any one or more of Examples 10-20 may optionally include, setting up a user profile of the first person on a cloud management service component.

In Example 22 the subject matter of any one or more of Examples 10-21 may optionally include, wherein the setting up the user profile comprises selecting companies to advertise and to track and collect rewards based on advertisements presented on the wearable device.

In Example 23 the subject matter of any one or more of Examples 10-22 may optionally include, analyzing a history of advertisements presented on the wearable device and receiving suggestions for companies and categories of companies to be presented.

In Example 24 the subject matter of any one or more of Examples 10-23 may optionally include, receiving feedback from nearby users and communicating the feedback to advertisers to close the loop between the advertisers and the wearable device of the first person.

Example 25 includes subject matter (such as a device, apparatus, client or system) for a serving node, including a communications network, a plurality of wearable devices, each wearable device associated with a user and a cloud management service component for storing profiles of each user associated with the plurality of wearable devices, wherein the plurality of wearable devices each include a display for presenting content including advertisements, a processor arranged to determine when an exposure of a display of a wearable device of a first person is acceptable for presentation of an advertisement and a sensor arranged to obtain information for determining an advertisement to present on the display of the wearable device, wherein the processor is further arranged to select the advertisement to present on the display of the wearable device based on the sensed information and presenting the selected advertisement on the display of the wearable device.

In Example 26 the subject matter of Example 25 may optionally include, wherein the processor is further arranged to determine when the display is pointing outward based on the sensor, including detecting the position and orientation of the display of the wearable device, to determine when the exposure of the display of the wearable device is acceptable for presentation of advertisements and to receive an advertisement for presentation on the display when the exposure of the display of the wearable device is acceptable for presentation of advertisements.

In Example 27 the subject matter of any one or more of Examples 25-26 may optionally include, wherein the processor is further arranged to obtain a reading from at least one sensor selected from a group consisting of an accelerometer, a gyroscope and at least one infrared (IR) sensor to determine that the display is pointing outward and not in the field of view of the user.

In Example 28 the subject matter of any one or more of Examples 25-27 may optionally include, wherein the processor is further arranged to select the advertisement to present on the display using context information.

In Example 29 the subject matter of any one or more of Examples 25-28 may optionally include, wherein the processor is further arranged to perform one selected from the group consisting of communicating real-time feedback from the nearby users to the wearable device presenting the advertisement, performing an interaction with a device of a second person to provide the advertisement to the device of the second person, communicating with the advertisement being presented using an application installed on the wearable device, setting up a user profile of the first person on a cloud management service component and selecting companies to advertise and to track and collect rewards based on advertisements presented on the wearable device.

In Example 30 the subject matter of any one or more of Examples 25-29 may optionally include, wherein the processor is further arranged to receive feedback from nearby users, to communicate the feedback to advertisers; to analyze a history of advertisements presented on the wearable device and to receive suggestions for companies and categories of companies to be presented to close the loop between the advertisers and the user.

Example 31 may include subject matter (such as means for performing acts or machine readable medium including instructions that, when executed by the machine, cause the machine to perform acts) including determining when an exposure of a display of a wearable device of a first person is acceptable for presentation of an advertisement, sensing information for determining an advertisement to present, selecting the advertisement to present on the wearable device based on the sensed information and presenting the selected advertisement on the display of the wearable device.

In Example 32 the subject matter of Example 31 may optionally include, wherein the determining when the exposure of the display of the wearable device is acceptable for presentation of the advertisement further comprises determining that the display is pointing outward based on at least one sensor including detecting the position and orientation of the wearable device.

In Example 33 the subject matter of any one or more of Examples 31-32 may optionally include, wherein the determining that the display is pointing outward based on at least one sensor comprises obtaining a reading from at least one selected from a group consisting of an accelerometer, a gyroscope and at least one infrared (IR) sensor.

In Example 34 the subject matter of any one or more of Examples 31-33 may optionally include, wherein the sensing information for determining the advertisement to present comprises sensing information from the wearable device, from nearby devices of others and from environmental contexts.

In Example 35 the subject matter of any one or more of Examples 31-34 may optionally include, wherein the sensing information for determining the advertisement to present comprises sensing information from user preferences in a profile, a location, identification of nearby businesses and a history of use of the wearable device.

In Example 36 the subject matter of any one or more of Examples 31-35 may optionally include, wherein the sensing information from nearby devices of others comprises sensing information from nearby devices of others using an IR sensor, a camera, sensors integrated into the display of the wearable device, a radio frequency identification (RFID) sensor, an audio sensor and a Bluetooth low energy sensor.

In Example 37 the subject matter of any one or more of Examples 31-36 may optionally include, wherein the selecting the advertisement to present on the wearable device based on the sensed information further comprises determining an advertisement to present on the wearable device based on user preferences, detection of nearby businesses and a profile associated with nearby devices.

In Example 38 the subject matter of any one or more of Examples 31-37 may optionally include, wherein the selecting the advertisement to present on the wearable device based on the sensed information further comprises selecting the advertisement to present on the wearable device using context information to determine how the advertisement should be shown and how much time the user will stay disconnected from a power source for identifying a type of content to present.

In Example 39 the subject matter of any one or more of Examples 31-38 may optionally include, further comprising communicating real-time feedback from the nearby users to the wearable device presenting the advertisement.

In Example 40 the subject matter of any one or more of Examples 31-39 may optionally include, performing an interaction with a device of a second person to provide the advertisement to the device of the second person.

In Example 41 the subject matter of any one or more of Examples 31-40 may optionally include, communicating with the advertisement being presented using an application installed on the wearable device.

In Example 42 the subject matter of any one or more of Examples 31-41 may optionally include, setting up a user profile of the first person on a cloud management service component.

In Example 43 the subject matter of any one or more of Examples 31-42 may optionally include, wherein the setting up the user profile comprises selecting companies to advertise and to track and collect rewards based on advertisements presented on the wearable device.

In Example 44 the subject matter of any one or more of Examples 31-43 may optionally include, analyzing a history of advertisements presented on the wearable device and receiving suggestions for companies and categories of companies to be presented.

In Example 45 the subject matter of any one or more of Examples 31-44 may optionally include, receiving feedback from nearby users and communicating the feedback to advertisers to close the loop between the advertisers and the wearable device of the first person.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplate are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure, for example, to comply with 37 C.F.R. §1.72(b) in the United States of America. It is submitted with the understanding that it will not be used to interpret or limit the scope or meaning of the claims. Also, in the above Detailed Description, various features may be grouped together to streamline the disclosure. However, the claims may not set forth features disclosed herein because embodiments may include a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

1-25. (canceled)

26. A wearable device providing context-aware social advertising, comprising:
a display arranged to present content including advertisements;
a sensor arranged to determine when an exposure of a display of a wearable device of a first person is acceptable for presentation of an advertisement; and
a processor arranged to obtain information for determining an advertisement to present on the display of the wearable device;
wherein the processor is further arranged to select the advertisement to present on the display of the wearable device based on the sensed information and present the selected advertisement on the display of the wearable device.

27. The wearable device of claim 26, wherein the processor is further arranged to determine when the display is pointing outward based on information obtained by the sensor, including a position and orientation of the display of the wearable device, to determine when the exposure of the display of the wearable device is acceptable for presentation of an advertisement.

28. The wearable device of claim 27, wherein the processor is further arranged to obtain a reading from at least one sensor selected from a group consisting of an accelerometer, a gyroscope and at least one infrared (IR) sensor to determine that the display is pointing outward and not in the field of view of the user.

29. The wearable device of claim 26, wherein the sensor obtains information from the wearable device, from nearby devices of others, from environmental contexts, from user preferences in a profile, regarding a location, regarding identification of nearby businesses and regarding a history of use of the wearable device.

30. The wearable device of claim 26, wherein the sensor comprises at least one selected from a group consisting of an IR sensor, a camera, a sensor integrated into the display of the wearable device, a radio frequency identification (RFID) sensor, an audio sensor and a Bluetooth low energy sensor.

31. The wearable device of claim 26, wherein the processor selects the advertisement to present on the display of the wearable device based on user preferences, detection of nearby businesses and a profile associated with nearby devices.

32. The wearable device of claim 26, wherein the processor is further arranged to select the advertisement to present on the wearable device using context information to determine how the advertisement should be shown and how much time the user will stay disconnected from a power source for identifying a type of content to present.

33. The wearable device of claim 26, wherein the processor is further arranged to perform one selected from the group consisting of communicating real-time feedback from nearby users to the wearable device presenting the advertisement, performing an interaction with a device of a second person to provide the advertisement to the device of the second person, communicating with the advertisement being presented using an application installed on the wearable device, setting up a user profile of the first person on a cloud management service component and selecting companies to advertise and to track and collect rewards based on advertisements presented on the wearable device.

34. The wearable device of claim 26 wherein the processor is further arranged to receive feedback from nearby users, to communicate the feedback to advertisers; to analyze a history of advertisements presented on the wearable device and to receive suggestions for companies and categories of companies to be presented to close a loop between the advertisers and the user.

35. At least one non-transitory machine readable medium comprising instructions that, when executed by the machine, cause the machine to perform operations for providing context-aware social advertising on wearable devices, the operations comprising:
determining when an exposure of a display of a wearable device of a first person is acceptable for presentation of an advertisement;
sensing information for determining an advertisement to present;
selecting the advertisement to present on the wearable device based on the sensed information; and
presenting the selected advertisement on the display of the wearable device.

36. The at least one non-transitory machine readable medium of claim 35, wherein the determining when the exposure of the display of the wearable device is acceptable for presentation of the advertisement further comprises determining that the display is pointing outward based on at least one sensor including detecting a position and orientation of the wearable device.

37. The at least one non-transitory machine readable medium of claim 36, wherein the determining that the display is pointing outward based on at least one sensor comprises obtaining a reading from at least one selected from a group consisting of an accelerometer, a gyroscope and at least one infrared (IR) sensor.

38. The at least one non-transitory machine readable medium of claim 35, wherein the sensing information for determining the advertisement to present comprises sensing information from the wearable device, from nearby devices of others and from environmental contexts.

39. The at least one non-transitory machine readable medium of claim 35, wherein the sensing information for determining the advertisement to present comprises sensing information from user preferences in a profile, a location, identification of nearby businesses and a history of use of the wearable device.

40. The at least one non-transitory machine readable medium of claim 35, wherein the sensing information from nearby devices of others comprises sensing information from nearby devices of others using an IR sensor, a camera, sensors integrated into the display of the wearable device, a radio frequency identification (RFID) sensor, an audio sensor and a Bluetooth low energy sensor.

41. The at least one non-transitory machine readable medium of claim 35, wherein the selecting the advertisement to present on the wearable device based on the sensed information further comprises determining an advertisement to present on the wearable device based on user preferences, detection of nearby businesses and a profile associated with nearby devices.

42. The at least one non-transitory machine readable medium of claim 35, wherein the selecting the advertisement to present on the wearable device based on the sensed information further comprises selecting the advertisement to present on the wearable device using context information to determine how the advertisement should be shown and how much time the user will stay disconnected from a power source for identifying a type of content to present.

43. The at least one non-transitory machine readable medium of claim 35 further comprising communicating real-time feedback from nearby users to the wearable device presenting the advertisement.

44. The at least one non-transitory machine readable medium of claim 35 further comprising performing an interaction with a device of a second person to provide the advertisement to the device of the second person.

45. The at least one non-transitory machine readable medium of claim 35 further comprising communicating with the advertisement being presented using an application installed on the wearable device.

46. The at least one non-transitory machine readable medium of claim 35 further comprising setting up a user profile of the first person on a cloud management service component.

47. The at least one non-transitory machine readable medium of claim 46, wherein the setting up the user profile comprises selecting companies to advertise and to track and collect rewards based on advertisements presented on the wearable device.

48. The at least one non-transitory machine readable medium of claim 35 further comprising analyzing a history of advertisements presented on the wearable device, receiving suggestions for companies and categories of companies to be presented, receiving feedback from nearby users and communicating the feedback to advertisers to close a loop between the advertisers and the wearable device of the first person.

49. A method for providing context-aware social advertising on wearable devices, comprising:
determining when an exposure of a display of a wearable device of a first person is acceptable for presentation of an advertisement;
sensing information for determining an advertisement to present;
selecting the advertisement to present on the wearable device based on the sensed information; and
presenting the selected advertisement on the display of the wearable device.

50. The method of claim 49, wherein the determining when the exposure of the display of the wearable device is acceptable for presentation of the advertisement further comprises determining that the display is pointing outward based on at least one sensor including detecting a position and orientation of the wearable device.
